(19) United States
(12) Patent Application Publication
(10) Pub. No.: US 2003/0100338 A1
(43) Pub. Date: May 29, 2003

(54) Personal digital assistant cover with an integrated keypad

(76) Inventor: Peter Lee, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 09/997,121

(22) Filed: Nov. 28, 2001

(51) Int. Cl. H04M 1/00

(52) U.S. Cl. 455/556; 455/550

(57) ABSTRACT

A cover for a personal computing device, such as a Personal Digital Assistant (PDA) is provided. The cover includes a user interface portion flexibly coupled to a support portion to allow the cover to be altered between closed and viewing positions. The cover supports a PDA in the viewing position, on a support surface, to provide ease of viewing the PDA's screen. The support portion is adjustable to adjust the viewing position of the cover, and thus, the angle with which the user views the PDA's screen. The support portion also retains the PDA in the viewing position, without requiring assistance by the user. Flexibly coupling the user interface portion to the support portion prevents the interface portion from interfering with accessing a user interface region of the PDA. The cover's user interface portion may include an integrated keyboard. The keyboard is located on an inner surface of the interface portion, so that the keyboard is readily available. The keyboard and PDA are interconnected via a data connection located on the cover and a data port on the PDA. A locking apparatus may be provided to retain the cover in the closed position.

### BACKGROUND OF THE INVENTION

1. Field of the Invention

The present invention relates generally to portable computing devices and, more particularly, to a personal digital assistant cover that includes an integrated keypad.

2. Description of Related Art

Portable computing devices, such as handheld personal computing devices known as Computerized Personal Organizers (CPOs) or Personal Digital Assistants (PDAs), are becoming increasingly popular. Personal Digital Assistants (PDAs) are typically capable of performing a number of varied functions. These functions may include performing organizational tasks, such as maintaining a date book, an address book, and a to-do list, for example. Additionally, PDAs may be capable of exchanging data with personal computers (PCs) and providing at least limited internet access as an option.

While these functions can be provided by conventional personal computers, they are often more conveniently provided by PDAs. PDAs are inexpensive, lightweight, and are dimensioned to be held in a user's hand. A user typically carries a PDA on their person so that they can readily access or modify data stored in the PDA.

PDAs are typically configured with a dual-function display assembly that serves as an input/output device. A stylus, or pen, is most frequently used to input and manipulate data in the PDA via a display screen of the display assembly. Data is entered and manipulated using the stylus, by positioning the stylus on the display screen and stroking or moving the stylus across the screen along predetermined paths. As the stylus is moved about on the screen, the display assembly senses the position and/or pressure of the tip of the stylus on the screen and optical character recognition software recognizes the data generated by the stylus, and processes the data. The display assembly also outputs images on the screen to create the illusion that the stylus is drawing the image directly upon the display screen.

Additionally, the PDA may be provided with one or more dedicated function buttons that may be positioned adjacent to the display screen. The buttons may be dedicated to a predetermined function, or functions, such as scrolling through various functional menus or providing limited data entry and manipulation functions.

Most PDAs are provided with a data port to allow uploading and downloading of data with a personal computer. A cradle, or other similar device, may be provided with a data connector that is configured complementary to the PDA's data port, to couple the PDA's data port to the cradle. The cradle is also coupled to a personal computer, laptop computer, or other similar computing device. When the PDA is coupled to the cradle, a data path is provided between the PDA and computing device to allow exchange of data therebetween.

However, a disadvantage common to PDAs is that it is relatively time consuming to input or manipulate large amounts of data. Also, the dedicated function buttons allow for only limited data input and manipulation. Thus, PDAs are not well suited for inputting or manipulating relatively large amounts of data or inputting data in an expedited manner.

Another disadvantage of PDAs relating to data entry and manipulation is that it is difficult to position the PDA for viewing. PDAs are typically not provided with an integral stand, or other device that supports the PDA at a suitable viewing angle. Therefore, the user's hand, for example, or other peripheral means, must support the PDA at a suitable viewing angle while the PDA is in use.

A further disadvantage common to PDA's is that they are susceptible to damage. Since users carry the PDA on their person, PDA's are prone to receiving various impact forces. For example, PDA's are often dropped, struck against various objects, and otherwise mishandled, any of which may sufficiently damage the PDA and render it non-operational. To inhibit damage from coming to the electronics of the PDA, the enclosure thereof usually comprises a lightweight and robust material, such as a known thermoplastic or similar material. However, the PDA's enclosure may break, crack, or otherwise fail, when receiving an impact force, which could significantly damage the PDA.

To prevent damage to the PDA, a number of carrying cases have been provided by the prior art. These carrying cases are configured to encase the PDA and may be fabricated from materials including leather, vinyl, nylon, or other similar protective material. Additionally, the carrying case may have a layer of foam padding to absorb impact forces.

A number of attempts have been made to overcome the above noted disadvantages. For example, an enclosure for a personal digital assistant having a cover catch member is disclosed in U.S. Pat. No. 5,555,175, to Moller et al. The disclosed enclosure includes a housing having top and bottom surfaces and a plurality of side surfaces. A pen-based computer, such as a PDA, can be disposed within the housing. A cover is coupled to the housing by a compound hinge that allows movement of the cover between a closed position and an open position.

U.S. Pat. No. 5,927,673 to Kurokawa et al. discloses an adjustable viewing stand for an electronic device. The device includes a base that is pivotally connected to a mounting plate. A viewing position can be selected by rotating the base to a desired position. A desired position can correspond to an upright position, where the electronic device can be viewed horizontally, or to a sloping position, where the electronic device can be viewed at an angle. Once the base is in the desired position, a selection arm can be inserted into a corresponding positioning receptacle located on the mounting plate to permit multiple viewing positions.

U.S. Pat. No. 6,178,085 to Leung discloses a calculator lid mechanism. The lid mechanism pivots a flat cover of a calculator in a predetermined controlled manner between a first position and a second operational position. In the first position, the flat cover overlies a calculator display to form a lid and in the second operational position, the cover is pivoted towards the rear of the calculator to form a stand for tilting the calculator into an upwardly inclined ergonomic position relative to a horizontal support surface during intended use thereof.

U.S. Pat. No. 6,168,331 to Vann, is directed to a case keyboard. The case keyboard is an input device that folds around an electronic instrument, such as a personal digital assistant (PDA), to protect the instrument and provide ease of transport. A first embodiment of the case keyboard comprises a standard set of keys on a substrate. A second embodiment comprises a touch-pad switch to multiplex the character designation of a small set of keys and a gentle motion of the thumb. Multiplexing reduces the number of keys while still providing designation of about 160 characters. A third embodiment incorporates the entire instrument into a case keyboard with a pop-up viewing screen flexibly attached.

A portable information processing apparatus is disclosed in U.S. Pat. No. 6,154,359 to Kamikakai et al. The portable apparatus includes a main body and a connection part. The connection part has a first rotary part rotatably connected to a second rotary part for supporting the main body and a display part relatively to each other. The first rotary part maintains a fixed angular relationship between the main body and the connection part and permits adjustment of the angle therebetween when a first rotary manipulation force is applied therebetween.

Related data entry devices are disclosed in U.S. Pat. No. 6,144,551 to Kao, U.S. Pat. No. 6,144,358 to Narayanaswamy et al., U.S. Pat. No. 6,172,620 to Brick et al., and U.S. Pat. No. 6,104,604 to Anderson et al.

### SUMMARY OF THE INVENTION

The present invention comprises a cover for a personal computing device, such as a Personal Digital Assistant (PDA). Preferably, the cover of the present invention is configured to be secured to a PDA and dimensioned to extend over the planar top and bottom surfaces of the PDA to inhibit damage thereto. The invented cover preferably includes a user interface portion coupled to a support portion.

In a preferred embodiment of the invented cover, the user interface portion is flexibly coupled to the support portion to allow the cover to be altered between a closed position and a viewing position. In the closed position, the interface portion extends over the PDA's top surface, which top surface includes a display screen and a user interface region, and over the PDA's back surface. The cover extends over the PDA's top and back surfaces to inhibit damage thereto.

The cover of the present invention is capable of supporting a PDA in a viewing position, wherein a PDA coupled to the cover is positioned at angle that provides ease of viewing the PDA's screen for a user. The cover's support portion preferably comprises a stand section pivotably coupled to a support section by a hinge mechanism. The support section couples to the PDA to support the PDA, when the cover is in the viewing position. The hinge enables the stand section to rotate away from the back surface of the PDA. In the preferred embodiment, the hinge moves between a closed position and a single open or stand position. In alternate embodiments, the hinges moves between several discrete angles or settings. Thus, in some embodiments, the angle that the stand section forms with the support section can be adjusted to modify the viewing position of the cover, and thus, the angle with which the user views the PDA's screen.

The cover is placed in the viewing position by first pivoting the user interface portion away from the PDA's top surface, so that it does not interfere with accessing the PDA's screen and user interface region. The stand section is then rotated away from the PDA's back surface until it forms a desired angle with the support section (the support position). Once the cover is placed in the viewing position, the cover, and thus the PDA, may then be placed on a support surface, such as a desktop for example. The support portion supports the PDA at an inclined angle that facilitates viewing of the PDA's display screen. Thus, the invented cover supports a PDA in the viewing position, without requiring assistance by the user.

In the preferred embodiments, the user interface portion of the invented cover includes a data entry and manipulation device, such as an integrated keyboard. The integrated keyboard is preferably located on an inner surface of the interface portion to enable viewing of the PDA's display screen, while the user is using the keyboard. The integrated keyboard is dimensioned to fit entirely on the inner surface of the interface portion, so that the keyboard does not have to be transported separately from the invented cover. Since the keyboard is not transported separately from the cover, the keyboard is readily accessible by the user.

The keyboard preferably includes one or more keys that provide data entry in a PDA coupled to the cover. For example, the integrated keyboard of the present invention may comprise a membrane keyboard that is made integral with the cover's interface portion. The keys of the keyboard may comprise pressure-sensitive areas located beneath a resilient shell or membrane. The keys may have a dedicated functionality, or the functionalities of certain keys can be user assigned.

The preferred embodiments use keypads configured as seen in the figures, however, in alternate embodiments the integrated keyboard may include an alphanumeric keypad configured in the traditional QWERTY configuration. Additionally, the keyboard may include one or more function keys. The integrated keyboard may optionally include a numeric keypad for performing arithmetic operations.

The integrated keyboard or keypad of the present invention is coupled to a data connection that may be located on an inner surface of the support section of the support portion. When a PDA is coupled to the support section, the invented cover's data connection couples to the PDA's data port, to interconnect the keyboard and the PDA. Once the PDA is interconnected with the keyboard, the user can readily input and manipulate data stored in the PDA using the keyboard.

The invented cover may also include a locking apparatus to retain the cover in the closed position. The locking apparatus may also be configured to pivot toward the back surface of the PDA, to provide additional support of the PDA while the cover is in the viewing position.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a perspective view of a preferred embodiment of the invention configured for use with a PALM PILOT™ brand personal digital assistant in a viewing position and showing a personal computing device coupled thereto.

FIG. 2 is a perspective view of a preferred embodiment of the invention configured for use with a VISOR™ brand personal computing device in a viewing position and showing a personal computing device coupled thereto.

FIG. 3 is a side view of the cover of FIG. 1.

FIG. 4 is a side view of the cover of FIG. 2.

FIG. 5 is a perspective view of a preferred embodiment of the cover of FIG. 1 without a personal computing device coupled thereto.

FIG. 6 is a perspective view of a preferred embodiment of the cover of FIG. 2 without a personal computing device coupled thereto.

FIG. 7 is a perspective view of the cover of FIG. 1 in a closed configuration.

FIG. 8 is a perspective view of the cover of FIG. 2 in a closed configuration.

### DESCRIPTION OF THE PREFERRED EMBODIMENTS

The following description is provided to enable any person skilled in the art to make and use the invention and sets forth the best modes presently contemplated by the inventor of carrying out the invention. Various modifications, however, will remain readily apparent to those skilled in the art, since the generic principles of the present invention have been defined herein.

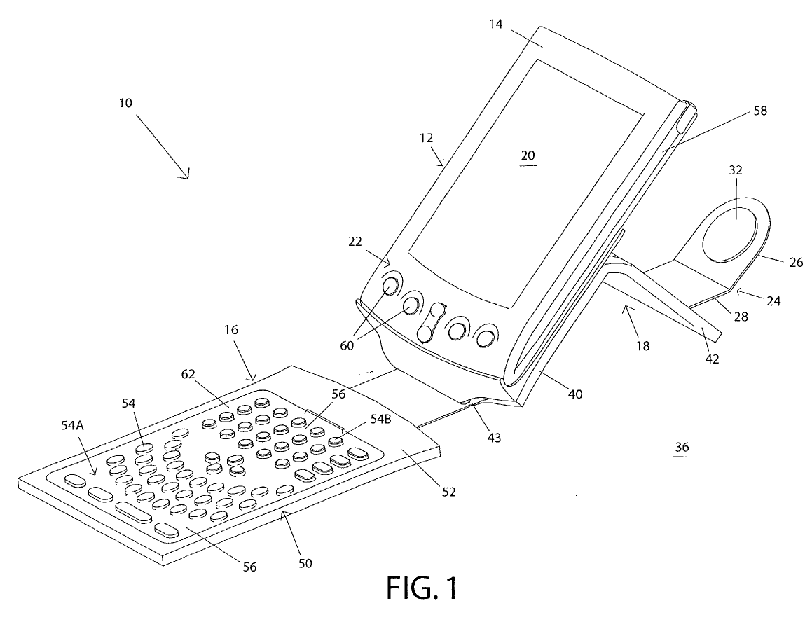

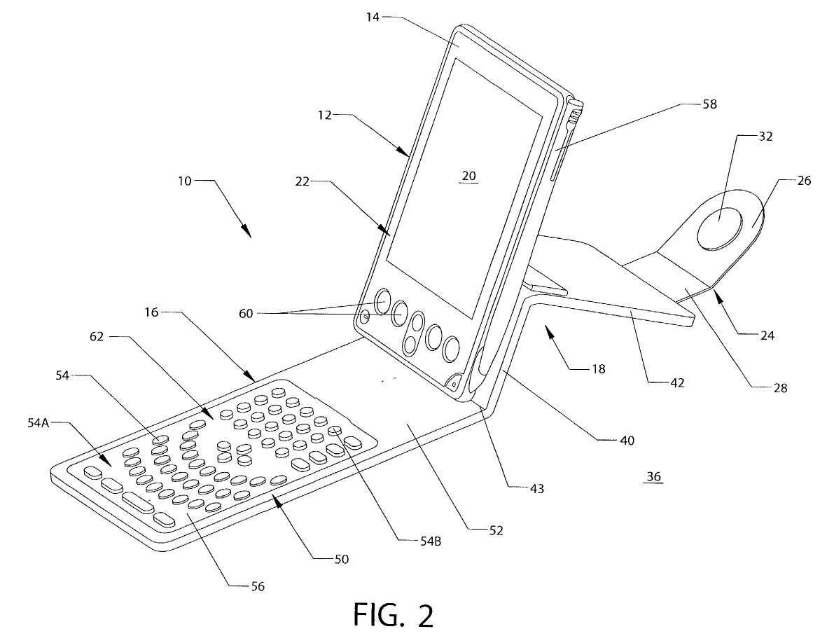

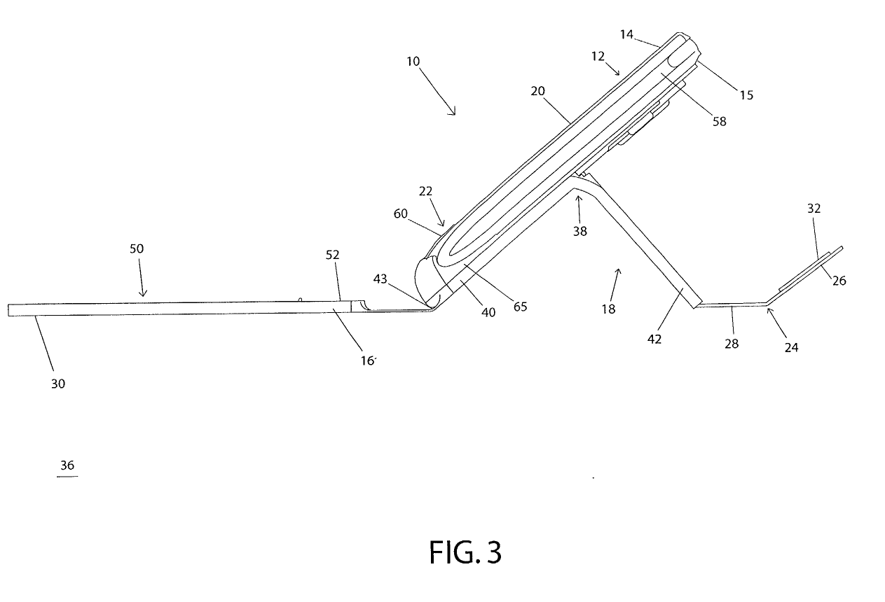

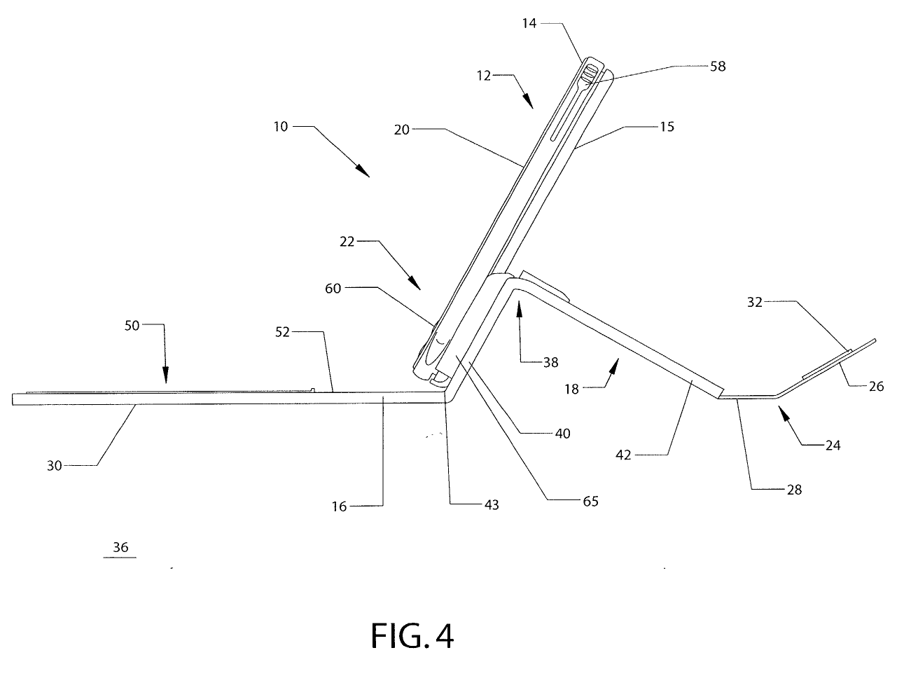

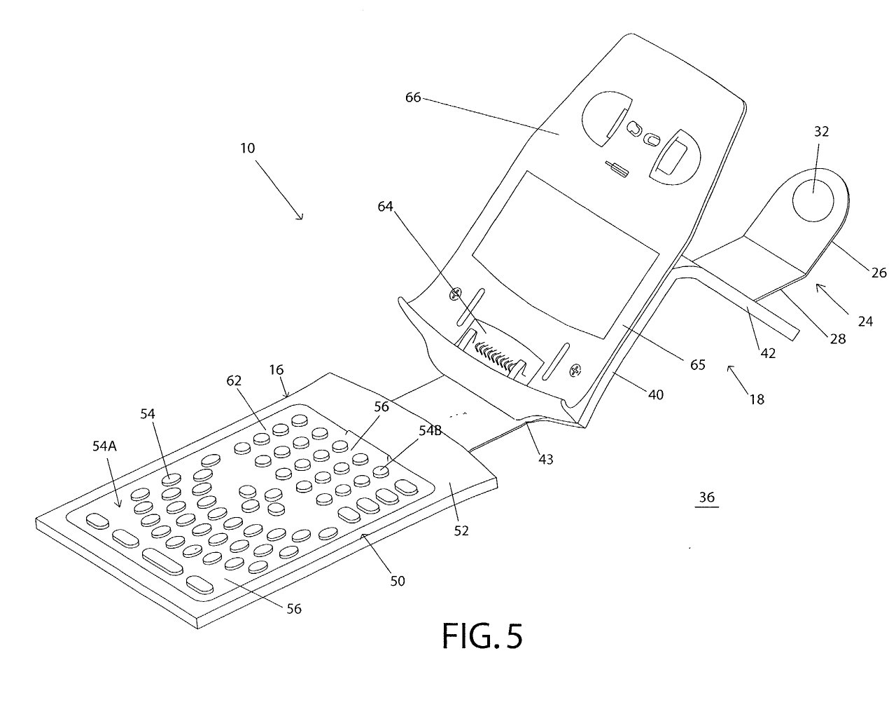

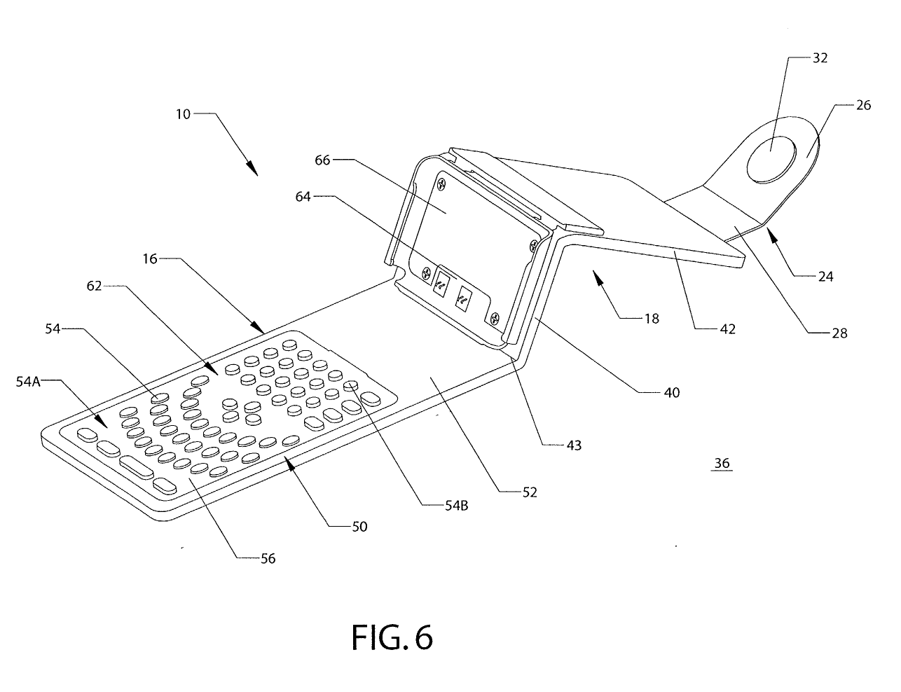

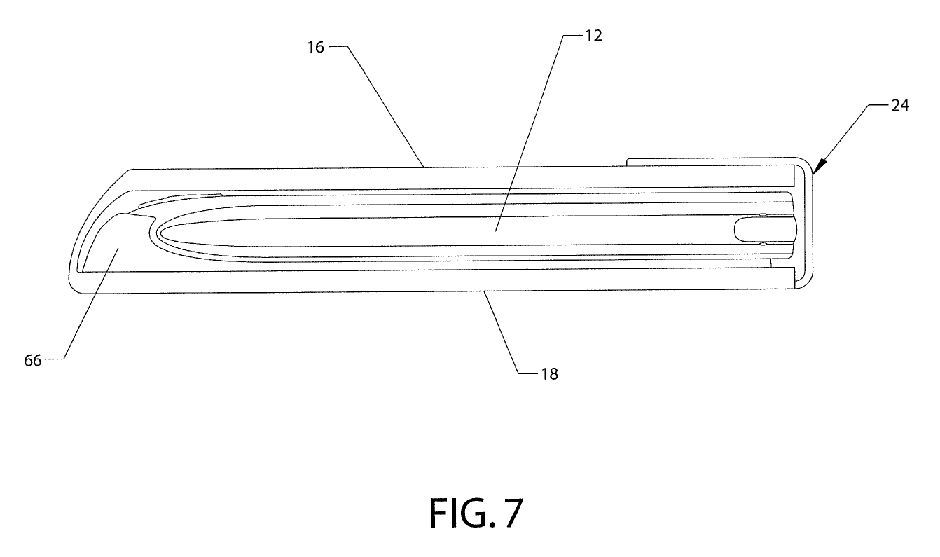

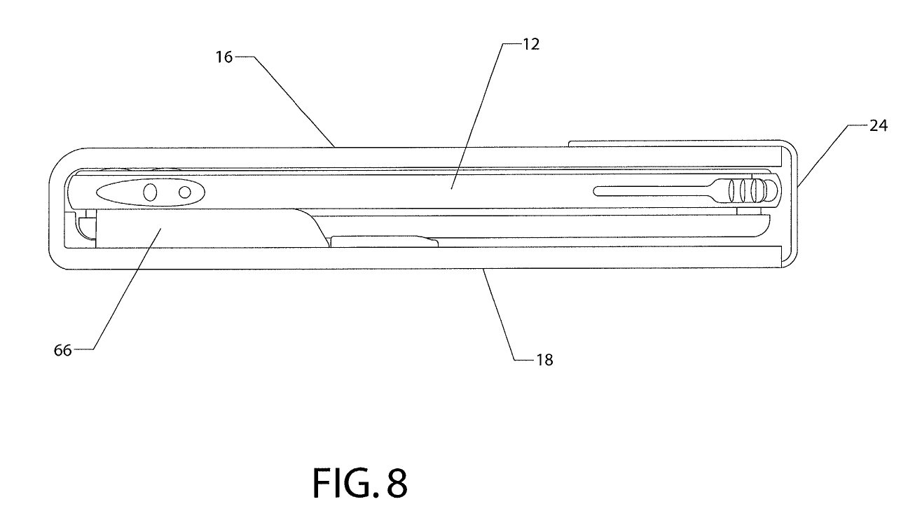

For example, the figures shown and discussed in this application are configured for use with PALM PILOT™ and VISOR™ brand personal digital assistants (PDA's). However, the cover of the invention may be easily modified by one skilled in the art to accommodate virtually any hand held device. Referring now to the drawings, FIGS. 1, 3, 5, and 7 show the cover of the invention configured for use with a PALM PILOT™. FIGS. 2, 4, 6, and 8 show the cover of the invention configured for use with a VISOR™. FIGS. 1 and 2 are perspective views showing the cover of the invention in the open position. FIGS. 3 and 4 are side views of the embodiments of FIGS. 1 and 2. FIGS. 5 and 6 are perspective views of the embodiments of FIGS. 1 and 2 in which the covers are open but without the PDA's. FIGS. 7 and 8 are perspective views of the embodiments of FIGS. 1 and 2 in the closed position. In the description below, like numbers will be used for like features in both embodiments shown in the figures.

Referring again to the figures, there is shown, a first preferred embodiment of a cover 10 for a personal computing device of the present invention. The cover 10 is preferably configured to protect a personal computing device, such as a known Personal Digital Assistant (PDA) 12 secured to the cover 10. The cover 10 preferably extends over a user interface surface 14 and a back surface 15 to inhibit damage from coming to the PDA 12. The cover 10 preferably comprises an appropriate lightweight, durable, and robust material, and is fabricated using techniques well known in the art. More preferably, the cover 10 comprises leather and is generally fabricated in accord with typical manufacturing processes.

The invented cover 10 preferably includes a user interface portion 16 that is flexibly coupled to a support portion 18 to allow the cover 10 to be altered between a viewing position, and a closed position. Flexibly coupling the user interface portion 16 to the support portion 18 enables the interface portion 16 to pivot away from the PDA's user interface surface 14 to prevent the cover 10 from interfering with the user accessing the features of the PDA 12. Each of the user interface portion 16 and support portion 18 has a height and a width substantially similar to the height and width of the PDA 12.

Since a user carries the PDA 12 on their person, the PDA 12 is prone to being dropped, struck against various objects, or otherwise mishandled, possibly resulting in damage the PDA 12. Preferably, the cover 10 is in the closed position, while the PDA 12 is in transit. When the cover 10 is in the closed position, the interface portion 16 extends over the PDA's user interface surface 14, that includes a display screen 20 and a user interface region 22. The cover's interface portion 16 inhibits, or minimizes, impact forces and other damaging forces from coming to the interface surface 14 to inhibit damage to the screen 20 and interface region 22. Similarly, in the closed position, the support portion 18 extends over the PDA's back surface 15 to minimize damaging forces to the PDA 12.

A locking apparatus 24 may be provided to retain the cover 10 in the closed position. The locking apparatus 24 preferably comprises a tongue 26 that is flexibly coupled to the stand section 42. The tongue 26 is preferably dimensioned to extend over a portion of an outer surface 30 of the interface portion 16.

An interlocking device 32 may be provided on an inner surface of the tongue 26 and on the outer surface 30 of the interface portion 16 to detachably couple the locking apparatus 24 to the interface portion 16, to prevent the locking apparatus 24 from inadvertently detaching from the interface portion 16 which may cause the cover 10 to open. When the two portions of the interlocking device 32 are joined, the locking apparatus's tongue 26 secures the support portion 18 to the interface portion 16 and retains the cover 10 in the closed position. The interlocking device 32 may comprise a snap fastener, interlocking loop and hook material, or any other suitable known interlocking device.

Referring particularly to FIG. 1 and FIG. 2 of the drawings, the cover 10 of the present invention is shown placed in a viewing position. When the cover 10 is in the viewing position, the cover 10 is capable of supporting the PDA 12 on a support surface 36, such as a desktop, tabletop, hard-sided briefcase, or any suitable planar surface, for example. The cover 10 supports the PDA 12 at an angle that provides ease of viewing the PDA's screen 20 and access to the user interface region 22.

In a preferred embodiment, the support portion 18 of the cover 10 includes a hinge mechanism 38 (best seen in FIGS. 3 and 4) that pivotably couples a support section 40 to a stand section 42. The PDA 12 may be secured to the support section 40 of the support portion 18 to support the PDA 12 at a viewing angle when the cover 10 is in the viewing position. The PDA 12 is also be electronically coupled to the support section 40, as will be thoroughly discussed hereinafter, to allow electronic communication with the keyboard 50.

The hinge 38 enables the stand section 42 to rotate away from the back surface 14 of the PDA 12, and form various desired angles with the support section 40. In the preferred embodiments, the hinge 38 has two discrete positions (closed against the back surface 15 of the PDA, and open to support the PDA in a viewing position). In alternate embodiments, the angle that the stand section 42 forms with the support section 40 can be altered to adjust the viewing position of the cover 10, and thus, the angle with which the user views the PDA's screen 20.

The cover 10 is changed from the closed position to the viewing position by first releasing the locking apparatus 24 from the interface portion 16, then rotating the locking apparatus 24 away from the interface portion 16. The locking apparatus 24 is rotated away from the interface portion 16 until its tongue 26 does not interfere with rotating the interface portion 16 away from the PDA 12. A flexible coupling 43 allows the interface portion 16 to then be rotated away from the user interface surface 14 of the PDA 12 until the screen 20 and user interface region 22 can be accessed by a user without obstruction from the interface portion 16. With the interface portion 16 rotated away from the screen 20 and interface region 22, the user may access the screen 20 and interface region 22, for data manipulation and/or for viewing data, without obstruction from the cover 10.

Once, the cover's interface portion 16 is rotated away from the PDA's user interface surface 14, the stand section 42 is pivoted away from the back surface 15 of the PDA 12. In the closed position the stand section 42 and support section 40 are generally aligned and extend along the PDA's back surface 15. The hinge 38 enables the stand section 42 to be pivoted away from the back surface 15, while the support section 40 supports the PDA 12. The stand section 42 is rotated away from the back surface 15 until it forms a desired angle with the support section 40 and extends generally outwardly from the PDA 12. Thus, the viewing position of the cover 10 is achieved.

Once the cover 10 is placed in the viewing position, the cover 10, and thus the PDA 12, is then placed on the support surface 36. The support portion 18 supports the PDA 12 at an inclined angle relative to the support surface 36, to facilitate viewing of the PDA's screen 20. The degree of inclination of the viewing position is adjusted by altering the angle that the stand section 42 forms with the support section 40. Therefore, the support portion 18 retains the PDA 12 in the viewing position, without requiring assistance by the user. Additionally, when the cover 10 is placed in the viewing position on a support surface 36, the interface portion 16 lies flatly on the support surface 36. The interface portion 16 lying on the support surface 36 may inhibit slippage between the cover 10 and surface 36.

The preferred embodiments use keypads configured as shown in the figures. However, in alternate embodiments the integrated keyboard may include an alphanumeric keypad configured in the traditional QWERTY configuration. Additionally, the keyboard may include one or more function keys, and the keyboard may optionally include a numeric keypad for performing arithmetic operations. The keyboard 50 allows a user to readily input and manipulate data stored in the PDA 12.

Referring again to FIG. 1 and FIG. 2 of the drawings, the integrated keyboard 50 is preferably located on an inner surface 52 of the interface portion 16. Locating the keyboard 50 on the inner surface 52 enables viewing of the screen 20 while the user is using the keyboard 50. Locating the keyboard 50 on the interface portion's inner surface 52 may also prevent damage from coming to the keyboard 50, while the cover 10 is in transit.

Most preferably, the keyboard 50 is dimensioned to fit within the periphery of the interface portion 16. The keyboard 50 comprises an integral component of the cover 10, so that the keyboard 50 is not transported separately from the cover 10. Additionally, lo since the keyboard 50 is contained in the cover 10, the keyboard 50 is always readily accessible by the user.

The keyboard 50 preferably includes one or more keys, shown generally at 54, that afford data entry and manipulation in a PDA 12 coupled to the cover 10. Preferably, the integrated keyboard 50 of the invented cover 10 may comprise a membrane keyboard that is made integral on the inner surface 52 of the interface portion 16.

Many known keyboard types may be used in the invention. The keys 54 of the keyboard 50 may comprise pressure-sensitive areas, or bumps, located beneath a resilient shell or membrane 56. The membrane 56 may comprise a continuous polymeric, rubber, or other suitable material membrane that extends over each of the keys 54. The membrane 56 may be translucent, opaque, or may be dyed or colored at various locations. The membrane 56 may be dyed or colored at various locations to indicate the various keys 54 of the keyboard 50, for example.

Alternatively, the keyboard 50 may be fabricated without bumps to indicate the positions of the keys 54. In this embodiment, the membrane 56 may be colored, marked, or other indicia may be provided, at various locations to indicate the position of pressure-sensitive areas beneath the membrane, which would function as the keys 54.

In either embodiment, the user can actuate the pressure-sensitive areas, or keys 54, of the keyboard 50 by pressing on the desired key, or keys 54. The user may use either their finger or a stylus 58 that may be provided with the PDA 12. The user may also use any suitable device for pressing the desired key or keys 54.

The keys 54 may have a dedicated functionality, as is well known. Alternatively, various functionalities of certain keys 54 of the keyboard 50 may be assigned by the user. In some alternate embodiments, the keys 54 on the integrated keyboard 50 may also supplant or duplicate some, or all, functions that may be provided by function buttons 60 provided in the PDA's user interface region 22.

The integrated keyboard 50 of the invented cover 10 may optionally include an alphanumeric keypad arranged as shown generally at 54A. Additionally, the keyboard 50 may include a function key area, shown generally at 62. One or more function keys 54B, similar to those typically provided on a known computer keyboard, may be provided in the function key area 62. Alternatively, the function key area 62 may include a number of numeric keys 54B in the known configuration of a numeric keypad of a calculator, for example. This configuration may be provided to allow the user to quickly perform arithmetic operations.

The keyboard 50 is coupled to a data connection that may be located on an inner surface 66 of the support portion's support section 40, best seen in FIGS. 5 and 6. For example, a support bracket 65 may be affixed to the support section's inner surface 66. The support bracket 65 is configured to detachably secure the PDA 12 to the cover 10. In alternate embodiments, the configuration of the support bracket 65 may be easily modified by one skilled in the art to couple to virtually any desired PDA. The data connection 66 may be positioned within the support bracket 65, such that when the PDA 12 is coupled to the bracket 65, the data connection 66 automatically engages a data port of the PDA 12. The configuration of the data connection will be governed by the need to couple to the data plug on the PDA. Thus the configuration of the data connection may be easily varied by one skilled in the art to couple to the data plug configuration of any PDA The PDA's data port allows data to be communicated between the PDA 12 and a peripheral device. When the PDA 12 is secured to the support bracket 65, the invented cover's data connection 64 couples to the PDA's data port, to couple the keyboard 50 to the PDA 12 for establishing a data path therebetween. Once the PDA 12 is coupled to the keyboard 50, the user can readily input and manipulate data stored in the PDA 12 using the keyboard 50.

Thus, there has been described an improved cover for a personal computing device, such as a Personal Digital Assistant (PDA). The cover supports the PDA in the viewing position, on the support surface, to provide ease of viewing the PDA's screen. The support portion is adjustable to adjust the viewing angle with which the user views the PDA's screen. The support portion also retains the PDA in the viewing position, without requiring assistance by the user. The integrated keyboard is positioned to be readily accessible by the user. The keyboard may allow expedited data entry and data manipulation in the PDA.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A cover for a personal computing device, the cover comprising:
a support portion including a stand section coupled to a support section, the support section configured to couple to a personal computing device for securing the computing device to the cover, the stand section pivotable away from a computing device secured to the cover and retained in a fixed position relative to the computing device for supporting the computing device at an inclined angle relative to a support surface, when the cover is placed on the support surface; and
a user interface portion coupled to the support portion, the user interface portion pivotable away from a user interface surface of a personal computing device secured to the cover to inhibit the cover from interfering with a user accessing the personal computing device.

2. The cover of claim 1 wherein the support portion extends generally parallel to a back surface of a personal computing device secured to the cover and the user interface portion extends generally parallel to the user interface surface of the personal computing device when the cover is in a closed position to inhibit damage to the personal computing device.

3. The cover of claim 2 wherein the stand section is generally aligned with the support section when the cover is in the closed position.

4. The cover of claim 2 further comprising:
a locking apparatus coupled to one of the support portion and user interface portion to inhibit the cover opening inadvertently.

5. A cover for a personal computing device, the cover comprising:
a support portion including a stand section pivotably coupled to a support section, the support section configured to secure a personal computing device to the cover and to electronically couple the personal computing device to the cover, the stand section pivotable between the personal computing device and support section until the stand section forms a desired angular relationship with the computing device, the stand section retained in its angular relationship to support the computing device at an inclined angle relative to a support surface, when the cover is placed on the support surface; and
a user interface portion coupled to the support portion, the user interface portion being pivotable away from a user interface surface of a personal computing device coupled to the cover to inhibit the interface portion from interfering with a user accessing the user interface surface of the personal computing device, the interface portion including a data entry and manipulation device coupled to a personal computing device coupled to the cover.

6. The cover of claim 5 wherein the support portion extends generally parallel to a back surface of a personal computing device secured to the cover and the user interface portion extends generally parallel to the user interface surface of the personal computing device when the cover is in a closed position to inhibit damage to the personal computing device.

7. The cover of claim 6 wherein the cover is altered from the closed position to a viewing position by pivoting the user interface portion away from the user interface surface of the personal computing device coupled to the cover, the stand section then being pivoted away from the back surface of the computing device and toward the support section until the stand section forms a desired angular relationship with the computing device, to position the cover in the viewing position, and whereby upon positioning the cover in the viewing position, the cover is placed on the support surface, such that the stand section supports the computing device at an inclined angle on the support surface to facilitate access to the user interface surface of the personal computing device.

8. The cover of claim 6 further comprising:
a locking apparatus coupled to the stand section, the locking apparatus configured to couple the user interface portion to the support portion to inhibit the cover from opening inadvertently.

9. The cover of claim 8 wherein the locking apparatus is further configured to abut the back surface of the personal computing device when the cover is positioned in a viewing position to aid with supporting the computing device.

10. The cover of claim 5 wherein the support section further comprises a data connection located on an inner surface thereof, the data connection configured to couple to a data port of a personal computing device to electronically couple the personal computing device to the data entry and manipulation device.

11. A cover for a personal computing device, the cover comprising:
a support portion including a stand section pivotably coupled to a support section, the support section configured to secure a personal computing device to the cover and to electronically couple the personal computing device to the cover, the stand section being pivotable between a back surface of a personal computing device secured to the cover and the support section, such that the stand section forms different desired angular relationships with the computing device, the stand section retained in a desired angular relationship with the computing device to support the computing device at a desired inclined angle relative to a support surface, when the cover is placed on the support surface; and
a user interface portion flexibly coupled to the support section, the user interface portion pivotable away from a user interface surface of a personal computing device coupled to the cover to inhibit the interface portion from interfering with a user accessing the user interface surface of the personal computing device, the interface portion including an integrated data entry and manipulation device electronically coupled to the personal computing device coupled to the cover, the data entry and manipulation device including at least one key that provides manipulation of data stored in the personal computing device.

12. The cover of claim 11 wherein the support section further comprises a support bracket located on an inner surface thereof, the support bracket configured to detachably secure a personal computing device to the cover, the support bracket housing a data connection configured to couple to a data port of a personal computing device.

13. The cover of claim 11 further comprising:
a hinge coupled to the support section and stand section for pivotably coupling the stand section to the support section, the hinge allowing the stand section to form different desired angular relationships with the computing device and retaining the stand section in a desired angular relationship with the computing device.

14. The cover of claim 11 further comprising:
a locking apparatus coupled to the stand section, the locking apparatus configured to detachably couple the user interface portion to the support portion to inhibit the cover from opening inadvertently, the locking apparatus configured to abut the back surface of the personal computing device when the cover is positioned in a viewing position to aid with supporting the computing device.

15. The cover of claim 11 wherein each the support portion and user interface portion has a height and a width substantially similar to a height and width of the personal computing device coupled to the cover.

16. The cover of claim 15 wherein the integrated data manipulation device is dimensioned to fit within the periphery of the interface portion.

17. The cover of claim 11 wherein the integrated data manipulation device is located on an inner surface of the user interface portion of the cover, the data manipulation device comprising a keyboard that includes at least one key that provides data entry and manipulation of data stored in the personal computing device coupled to the cover, the keyboard coupled to the data connection for coupling the keyboard to the personal computing device.

18. The cover of claim 17 wherein the integrated keyboard comprises a membrane keyboard.

19. The cover of claim 17 wherein the integrated keyboard includes an alphanumeric keypad configured in a QWERTY configuration.
